(19) United States
(12) Patent Application Publication
(10) Pub. No.: US 2008/0076864 A1
(43) Pub. Date: Mar. 27, 2008

(54) SILICONE RUBBER COMPOSITION WHICH CURES BY CONDENSATION

(75) Inventor: Hiroshi MOGI, Annaka-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 11/857,836

(22) Filed: Sep. 19, 2007

(30) Foreign Application Priority Data
Sep. 22, 2006 (JP) 2006-257315
Apr. 18, 2007 (JP) 2007-109327

(51) Int. Cl. C08L 83/00; C08K 3/16; C08K 3/18; C08K 3/30; C08K 3/32; C08K 3/38

(52) U.S. Cl. 524/404; 524/408; 524/410; 524/414; 524/423; 524/588

(57) ABSTRACT

A silicone rubber composition which cures by condensation is provided. After curing, the silicone rubber exhibits excellent insulation and antistatic properties, and this silicone rubber has overcome the problem of electrostatic adsorption of the dust in the air in the applications including a master template, tampon printing, and a large size industrial roll. The silicone rubber composition which cures by condensation contains an ion conductive antistatic agent.

### CROSS-REFERENCE TO RELATED APPLICATION

This non-provisional application claims priority under 35 U.S.C. §119(a) on Patent Application Nos. 2006-257315 and 2007-109327 filed in Japan on Sep. 22, 2006 and Apr. 18, 2007, respectively, the entire contents of which are hereby incorporated by reference.

### TECHNICAL FIELD

This invention relates to a silicone rubber composition which cures by condensation, and more specifically, to a silicone rubber composition which exhibits excellent antistatic properties and electric insulation.

### BACKGROUND ART

Silicone rubbers have excellent weatherability and electric properties, low compression set, improved heat resistance, low temperature resistance, and other properties, and therefore, silicone rubbers are used in a wide diversity of fields including electric appliance, automobiles, construction materials, medicine, foods. Among these, the room temperature curable silicone rubber composition which cures by condensation provides an elastomeric cured product by curing at room temperature, and therefore, the silicone rubber composition of this type is widely used for an insulation material, a sealant, a potting material, a master template, tampon printing, and a large size industrial roll. In the case of a large size industrial roll used in a large size drawing machine, the roll is quite large and typically has a diameter of 1 m and a length of 5 m. The roll produced by using a peroxide curable silicone rubber has the problem in the joint at which the cured article are abutted, and production of such roll from a high temperature curable silicone rubber which cures by addition is difficult because of the size, and therefore, a room temperature curable silicone rubber which cures by condensation is used in the production of such roll.

These silicone rubbers are typically supplied in the form of a composition containing an organopolysiloxane having a high degree of polymerization and a reinforcement filler, and such composition is typically prepared by mixing the base polymer with the reinforcement filler and a dispersants by using a blending apparatus such as dough mixer and dual rolls. The organopolysiloxane and the reinforcement filler such as silica are electrical insulators, and the silicone rubber composition obtained by blending such components and the silicone rubber produced by curing such composition suffered from the problem of charge deposition when they were brought in contact with another material and this resulted in the problem of static electricity and adsorption of dust in the air. In particular, in the case of an industrial large size drawing rolls used in a drawing machine for stretching a plastic film, such dust deposition resulted in the serious problem of pin hole generation in the plastic films drawn by such roll.

Antistatic rubbers have been prepared by using an antistatic agent such as polyether antistatic agent (JP-A 2002-500237: Patent Document 1) and carbon black (JP-A 2002-507240: JP-A 2002-327122: Patent Documents 2 and 3). Among these, the polyether antistatic agent had the problem that it decomposes at an elevated temperature not fulfilling the sufficient antistatic effects.

### DISCLOSURE OF THE INVENTION

The present invention has been completed in view of the situation as described above, and an object of the present invention is to provide a silicone rubber composition which cures by condensation to produce a silicone rubber exhibiting excellent insulation and antistatic properties, and which has overcome the problem of electrostatic adsorption of the dust in the air in the applications including a master template, tampon printing, and a large size industrial roll.

In order to realize such objects, the inventors of the present invention made an intensive study and found that, when a small amount of an ion conductive antistatic agent is added to the silicone rubber composition which cures by condensation, the cured composition exhibits excellent insulation as well as improved antistatic properties. The present invention has been completed on the basis of such finding.

Accordingly, the present invention provides a silicone rubber composition which cures by condensation, and this composition contains an ion conductive antistatic agent. The composition exhibits excellent antistatic property after its curing.

### EFFECTS OF THE INVENTION

The silicone rubber composition which cures by condensation according to the present invention provides a cured article exhibiting excellent insulation and antistatic properties, and the article also permits free coloring.

### DESCRIPTION OF THE PREFERRED EMBODIMENTS

The silicone rubber composition which cures by condensation of the present invention contains an ion conductive antistatic agent.

The silicone rubber composition which cures by condensation used in the present invention is the one which cures at room temperature, and in particular, the one containing an organopolysiloxane having at least two silanol groups per molecule as a base polymer, optionally with a reinforcement filler such as silica and a curing agent such as an alkoxysilane. More preferably, the silicone rubber composition which cures by condensation used in the present invention is the one prepared by blending the following components (A) to (E):

(A) an organopolysiloxane having at least two silanol groups per molecule,

(B) a fine silica powder,

(C) a tin curing catalyst,

(D) a crosslinking agent, and

(E) an ion conductive antistatic agent.

### [(A) Organopolysiloxane Having at Least Two Silanol Groups per Molecule]

Component (A) may comprise a compound represented by the following average compositional formula (1):

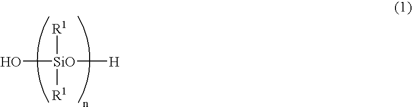

wherein R¹ is independently an optionally substituted monovalent hydrocarbon group, and n is a positive number which realizes a viscosity at 25° C. of 0.0001 to 0.5 mm²/S.

Examples of the optionally substituted monovalent hydrocarbon group represented by the R¹ in the general formula (1) include a lower alkyl group containing up to 10 carbon atoms, preferably 1 to 8 carbon atoms, and more preferably 1 to 6 carbon atoms such as methyl group, ethyl group, propyl group, and butyl group; an alkenyl group such as vinyl group, allyl group, isopropenyl group, butenyl group, and hexenyl group; (meth)acryloyl group; (meth)acryloyloxy group; a cycloalkyl group such as cyclohexyl group; an aryl group such as phenyl group, tolyl group, and naphthyl group; an aralkyl group such as benzyl group and 2-phenylethyl group; and any one of such groups having the hydrogen atom entirely or partly substituted with a halogen atom, for example, chloromethyl group and 3,3,3-trifluoropropyl group; which contain 1 to 10 carbon atoms, preferably 1 to 8 carbon atoms, and more preferably 1 to 6 carbon atoms. These monovalent hydrocarbon group may have the hydrogen atom entirely or partly substituted with hydroxyl group. Among these, the preferred are methyl group, phenyl group, and 3,3,3-trifluoropropyl group, and the most preferred is methyl group.

The number of the repeating unit n is a number such that the organopolysiloxane will have a viscosity at 25° C. of 0.0001 to 0.5 mm²/S, preferably 0.0005 to 0.1 mm²/s, and most preferably 0.0005 to 0.05 mm²/s. In the present invention, the viscosity may be measured by Ostwald viscometer.

The organopolysiloxane represented by the general formula (1) is typically produced by mixing an organocyclopolysiloxane with an alkali catalyst or an acid catalyst, heating the mixture to promote an equilibrating reaction including cleavage and re-binding of the siloxane bond, and terminating the reaction by using water or a low molecular weight compound containing silanol group.

Examples of the alkali catalyst used include potassium hydroxide, tetraalkylphosphonium hydroxide, and tetraalkylammonium hydroxide, the preferred is potassium hydroxide. Examples of the acid catalyst include sulfuric acid, methanesulfonic acid, and trifluoromethanesulfonic acid, and the preferred is the methanesulfonic acid.

Non-limiting examples of the organopolysiloxane used in the present invention include those represented by the following general formulae (2-1) to (2-5) in which Ph represents phenyl group.

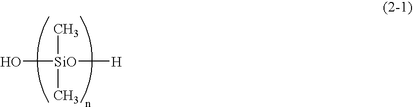

### In this formula, n is a number which realizes the viscosity at 25° C. of 0.0001 to 0.5 mm²/s.

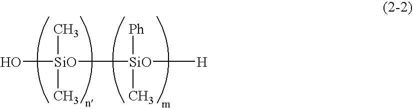

### In this formula, m is an integer of at least 1, n′ is an integer of at least 0, with the proviso that m+n′ is a number which realizes the viscosity at 25° C. of 0.0001 to 0.5 mm²/S.

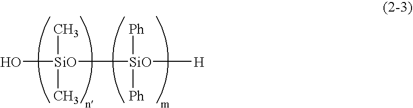

### In this formula, m is an integer of at least 1, n′ is an integer of at least 0, with the proviso that m+n′ is a number which realizes the viscosity at 25° C. of 0.0001 to 0.5 mm²/S.

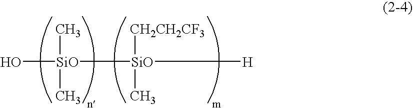

### In this formula, m is an integer of at least 1, n′ is an integer of at least 0, with the proviso that m+n′ is a number which realizes the viscosity at 25° C. of 0.0001 to 0.5 mm²/S.

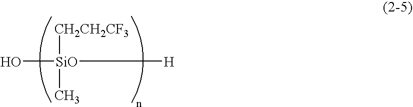

### In the formula, n is a number which realizes the viscosity at 25° C. of 0.0001 to 0.5 mm²/s.

### [(B) Fine Silica Powder]

The silicone rubber composition which cures by condensation according to present invention preferably comprises an organopolysiloxane of the component (A) having blended therewith a fine silica powder (B) in view of realizing the desired properties such as mechanical strength.

The fine silica powder used for the reinforcement preferably has its surface hydrophobically modified with a hydrophobic agent (an organosilicon compound). The hydrophobic modification prevents increase in the viscosity by the gradual aggregation of the silicone compound after mixing with the component (A), and as a consequence, a sufficient pot life required for the working is realized after the mixing with the curing catalyst and curing agent (an alkoxysilane).

The fine silica powder treated by the hydrophobic agent is not particularly limited, and examples include those used for the conventional silicone rubber compositions such as precipitated silica, fumed silica, and calcined silica. The preferred is use of fumed silica in view of its capability of improving the rubber strength.

The surface treating agent used for the fine silica powder is an organosilicon compound comprising a monomer containing a hydrolyzable group or its partial hydrolysis and condensation product. More specifically, the surface treating agent is preferably the one which is capable of covering the fine silica powder with monomethylsilyl group, dimethylsilyl group, trimethylsilyl group, or the like (wherein, all bonds of the silicon atom in the silyl group are engaged in the bonding with the oxygen atom constituting the siloxane structure represented by Si—O—Si except for those engaged in the bonding with the methyl group). Exemplary surface treating agents include hexaorganodisilazanes such as 1,3-divinyltetramethyldisilazane, 1,3-dimethyl tetravinyldisilazane, and hexamethyldisilazane; organosilazanes such as octamethyltrisilazane, and 1,5-divinylhexamethyltrisilazane; alkyltrialkoxysilanes such as methyltrimethoxysilane, ethyltrimethoxysilane, propyltrimethoxysilane, and butyltrimethoxysilane; dialkyldialkoxysilanes such as dimethyldimethoxysilane, diethyldimethoxysilane, dimethyldiethoxysilane, and diethyl diethoxysilane; alkenyltrialkoxysilanes such as vinyltriethoxysilane, vinyltrimethoxysilane, and vinyltris(methoxyethoxy)silane; dialkenyldialkoxysilane such as divinyldimethoxysilane and divinyldiethoxysilane; trialkylalkoxysilanes such as trimethylmethoxysilane and triethylmethoxysilane; trialkenylalkoxysilanes such as trivinylmethoxysilane and trivinylethoxysilane; organochlorosilanes such as trimethylchlorosilane, dimethyldichlorosilane, methyltrichlorosilane, vinyltrichlorosilane, divinyldichlorosilane, and trivinylchlorosilane; silane coupling agents such as chloropropyltrimethoxysilane; and organosilicon compounds such as dimethylpolysiloxane and organohydrogen polysiloxane; and their partial hydrolysis and condensation products. Among these, the preferred are silane coupling agents wherein all substituents of the silicon atom are methyl group except for the hydrolyzable groups, and organosilazanes, and the most preferred are organosilazanes.

Preferably, the fine silica powder is preliminarily hydrophobically modified in powder state. The method used in the hydrophobic modification of the silica surface is not particularly limited, and any method known in the art may be used for the treatment. In an exemplary treatment, the fine silica powder to be treated and the surface treating agent are introduced in a sealed mechanical kneader at room temperature, and mixture is kneaded at room temperature or at an elevated temperature in the optional presence of an inert gas and with optional use of a catalyst. After the kneading, the mixture is dried to produce the surface treated product.

This hydrophobic modification converts silanol group on the silica to a hydrophobic group. Amount of the hydrophobic group on the silica after the conversion is preferably at least 2.0% by weight, more preferably 2.0 to 20% by weight, even more preferably 2.5 to 12% by weight, and most preferably 3.0 to 8% by weight in terms of carbon. When the amount of the hydrophobic group on silica in terms of carbon is less than 2.0% by weight, the silicone compound after the mixing may suffer from insufficient long term stability.

The carbon amount of the hydrophobic group on silica surface may be calculated from ¹³C-NMR data of the —O—Si(CH₃)₃ produced by the treatment with silazane or the like of the hydroxyl group of the silanol group on the silica surface.

The hydrophobically modified fine silica powder may preferably have a specific surface area measured by BET adsorption of at least 50 m²/g, more preferably 50 to 600 m²/g, and most preferably 100 to 400 m²/g. The specific surface area of less than 50 m²/g may result in an unduly low strength of the silicone compound.

The hydrophobically modified fine silica powder as described above may be used alone or in combination of two or more such powders.

The component (B) is preferably incorporated at an amount of 1 to 100 parts by weight, more preferably at 5 to 50 parts by weight, and most preferably at 10 to 40 parts by weight in relation to 100 parts by weight of the component (A). When incorporated at 1 to 100 parts by weight, the resulting silicone rubber composition which cures by condensation will have excellent mechanical strength, working adaptability, and workability.

### [(C) Tin Curing Catalyst]

The tin curing catalyst (C) is used for promoting the curing of the silicone rubber composition which cures by condensation. Examples include metal carboxylate salts such as tin octoate, tin caprylate, and tin oleate; and organotin compounds such as dimethyltin diversatate, dibutyltin diversatate, dibutyltin diacetate, dibutyltin dictoate, dibutyltin dioleate, diphenyltin diacetate, dibutyltin oxide, dibutyltin dimethoxide, dibutyl bis(triethoxy)tin, and dioctyltin dilaurate. The preferred is use of an organotin compound having a metal tin content of 1 to 50% by weight, preferably 5 to 40% by weight, and more preferably 8 to 35% by weight.

The component (C) may be incorporated at a catalytic amount. More specifically, the component (C) is preferably incorporated at 0.01 to 10 parts by weight, more preferably at 0.1 to 5 parts by weight, and most preferably at 0.2 to 4 parts by weight in relation to 100 parts by weight of the component (A). When the content is 0.01 to 10 parts by weight, the resulting silicone rubber composition which cures by condensation will exhibit an excellent curability and mold releasability, and when a master template is produced by curing the composition, the resulting master template will exhibit high durability when used for molding with urethane, and the cured silicone rubber will also exhibit excellent storage stability, heat resistance, and other properties.

### [(D) Crosslinking Agent]

The silicone rubber composition which cures by condensation of the present invention may optionally contain a crosslinking agent (D) together with the curing catalyst (C) in order to increase crosslink density of the cured product. Exemplary preferable crosslinking agent is the compound represented by the following general formula (3):

R²ₐSiX₄₋ₐ (3)

and/or or its partial hydrolysis and condensation product. In the formula, R² is an optionally substituted monovalent hydrocarbon group, X is a hydrolyzable group, and a is 0 or 1.

Exemplary optionally substituted monovalent hydrocarbon group represented by R² in the general formula (3) include those as mentioned above for the R¹, and the preferred are methyl group, ethyl group, propyl group, butyl group, vinyl group, and phenyl group, and the most preferred is methyl group.

Exemplary hydrolyzable groups represented by X include alkoxy groups such as methoxy group, ethoxy group, propoxy group, and butoxy group, ketoxime groups such as methyl ethyl ketoxime group, alkenyloxy groups such as isopropenoxy group, acyloxy groups such as acetoxy group, and aminoxy groups such as dimethylaminoxy group, and the preferred are alkoxy groups, and the most preferred are methoxy group and ethoxy group.

Exemplary crosslinking agents include trifunctional alkoxysilanes such as methyltrimethoxysilane, methyltriethoxysilane, ethyltrimethoxysilane, ethyltriethoxysilane, butyltrimethoxysilane, butyltriethoxysilane, vinyltrimethoxysilane, phenyltrimethoxysilane, and methyltris(methoxyethoxy)silane; tetrafunctional alkoxysilanes such as tetramethoxy silane, tetraethoxy silane, and tetrapropoxy silane; methyltripropenoxysilane, methyltriacetoxysilane, vinyltriacetoxysilane, methyltri(butanoxime)silane, vinyltri(butanoxime)silane, phenyltri(butanoxime)silane, propyltri(butanoxime)silane, tetra(butanoxime)silane, 3,3,3-trifluoropropyltri(butanoxime)silane, 3-chloropropyltri(butanoxime)silane, methyltri(propanoxime)silane, methyltri(pentanoxime)silane, methyltri(isopentanoxime)silane, vinyltri(cyclopentanoxime)silane, methyltri(cyclohexanosime)silane, and partial hydrolysis and condensation product thereof. The preferred are alkoxysilanes and their partial hydrolysis and condensation products.

The component (D) is preferably added at an amount of 0.1 to 10 parts by weight, more preferably at 0.2 to 8 parts by weight, and most preferably 0.3 to 5 parts by weight in relation to 100 parts by weight of the component (A). The addition of less than 0.1 parts by weight may result in the insufficient curing of the silicone compound, while the addition in excess of 10 parts by weight may result in the failure of realizing the predetermined physical properties (hardness and strength).

### [(E) Ion Electroconductive Antistatic Agent]

In the present invention, an ion conductive antistatic agent is blended as component (E) in the silicone rubber composition which cures by condensation containing the components (A) to (D).

The ion conductive antistatic agent incorporated in the silicone rubber composition which cures by condensation of the present invention is not particularly limited as long as it is an ion conductive substance and not an electron conductive substance such as carbon black. The preferred are lithium salts.

Exemplary such lithium salts include LiBF₄. LiClO₄, LiPF₆, LiAsF₆, LiSbF₆, LiSO₃CF₃, LiN(SO₂CF₃)₂, LiSO₃C₄F₉, LiC(SO₂CF₃)₃, and LiB(C₆H₅)₄ which may be used alone or in combination of two or more.

In order to improve dispersibility in the silicone rubber composition which cures by condensation to thereby stably realize the benefits, the ion conductive antistatic agent is preferably incorporated in the form of a paste by mixing the ion conductive antistatic agent with an organopolysiloxane. In such case, the organopolysiloxane used may be either in the form of a raw rubber or an oil, and the organopolysiloxane is preferably polydimethylsiloxane or polymethylvinylsiloxane. In order to improve workability, a filler such as reinforcement silica or diatomaceous earth may be incorporated in this paste. In this case, the organopolysiloxane may be a portion of the organopolysiloxane of the component (A), and the filler may be a portion of the fine silica powder of the component (B).

Concentration of the ion conductive antistatic agent in the paste is preferably 2 to 90% by weight, more preferably 5 to 80% by weight, and most preferably 10 to 50% by weight. Concentration of the ion conductive antistatic agent less than 2% by weight may result in an insufficient antistatic performance, and concentration in excess of 90% by weight may invite an unduly high quality variation.

The ion conductive antistatic agent is added at an amount of 0.0001 to 5 parts by weight, preferably at 0.0005 to 3 parts by weight, more preferably at 0.001 to 1 parts by weight, and most preferably at 0.001 to 0.5 parts by weight in relation to 100 parts by weight of the component (A) which is the base polymer. The addition at an amount of less than 0.0001 parts by weight may results in an insufficient antistatic effect, while the addition at an amount in excess of 5 parts by weight may result in the loss of insulating properties or adverse effects on the physical properties and heat resistance of the silicone rubber.

### [Other Optional Components]

The silicone rubber composition of the present invention may also contain optional additives other than the components (A) to (E) as described above in order to further improve other properties of the composition. Such optional additives may be added to the extent that the benefits of the silicone rubber composition which cures by condensation of the present invention are not adversely affected.

An exemplary additive is dimethylpolysiloxane having both ends endcapped with trimethylsilyl group added as a diluent for the purpose of adjusting the viscosity. Another example is carbon black which is added as a reinforcement filler, as an agent for preventing precipitation, or as an additive for providing electroconductivity. Quartz powder, molten quartz, spherical silica, diatomaceous earth, zeolite, calcium carbonate, titanium dioxide, iron oxide, alumina, spherical alumina, aluminum hydroxide, aluminum nitride, and magnesium sulfate may also be added as a filler, extender or a thermoconductive filler. Lead compound in the form of a carbonate or a hydroxide may be added for shielding radiation. Exemplary other additives include a colorant such as an inorganic pigment or an organic dye; and an agent for improving the heat resistance or flame retardancy such as cerium oxide, zinc carbonate, manganese carbonate, benzotriazole, or platinum compound. Also, water; an alcohol such as methanol, ethanol, or propanol; or a cellosolve such as methyl cellosolve may be added to promote curing of the composition, or to promote uniform curing of the composition all over the composition.

The silicone rubber composition of the present invention may be prepared by mixing the components (A) to (E) and other optional components in a mixer known in the art such as planetary mixer and Shinagawa mixer. More specifically, this mixing may be accomplished by mixing the components (A) and (B), and then adding the ion conductive antistatic agent component, the component (D), and the component (C).

The resulting silicone rubber composition is curable at room temperature, and more specifically, the silicone rubber composition may be cured at 10 to 30° C. for 16 to 72 hours.

The resulting silicone rubber composition may preferably have a volume resistivity of at least 1 GΩ·m, and in particular, at least 2 GΩ·m in view of realizing the insulation sufficient for practical use.

The antistatic property of the silicone rubber composition after curing may be evaluated with a static honestmeter (manufactured by Shishido Electrostatic, Ltd.) by treating the surface of an article with corona discharge to build static charge to 6 kV, and measuring the time required for the voltage to become half its initial level (half life), and this time (half life) is preferably within 2 minutes, and in particular, within 1 minute.

The silicone rubber composition which cures by condensation of the present invention can be used in wide variety of applications since the composition after curing has excellent insulation and antistatic properties.

Exemplary such applications include an insulation, a sealant, a potting material, a material for producing a master template, a material for tampon printing, a large size industrial roll used, for example, in a large size industrial drawing machine.

### EXAMPLES

Next, the present invention is described in further detail by referring to Example and Comparative Examples which by no means limit the scope of the present invention.

Charge amount and intrinsic volume resistivity were measured by the procedure as described below.

### Evaluation of Charge Amount

Charge amount was evaluated with a static honestmeter (manufactured by Shishido Electrostatic, Ltd.) by treating the surface of an article with corona discharge to build static charge to 6 kV, and measuring the time required for the voltage to become half its initial level (half life).

### Evaluation of Volume Intrinsic Reeistivity

Volume intrinsic resistivity was measured according to JIS-K6249.

An antistat paste was prepared by the procedure as described below.

### [Preparation of Antistat Paste 1]

42 parts by weight of dimethylpolysiloxane endcapped with trimethylsilyl group, 8 parts by weight of hydrophobically modified fumed silica having a specific surface area of 110 m²/g (R-972 manufactured by Nippon Aerosil), and 50 parts by weight of adipic acid ester containing 20% by weight of LiN(SO₂CF₃)₂ were kneaded to prepare antistat paste 1.

### [Preparation of Antistat Paste 2]

42 parts by weight of dimethylpolysiloxane endcapped with trimethylsilyl group, 8 parts by weight of hydrophobically modified fumed silica having a specific surface area of 110 m²/g (R-972 manufactured by Nippon Aerosil), and 50 parts by weight of polyether modified silicone oil (KF351F, manufactured by Shin-Etsu Chemical Co., Ltd.) having a viscosity at 25° C. of 75 mm²/S were kneaded to prepare antistat paste 2.

### Example 1

100 parts by weight of dimethylpolysiloxane having both ends endcapped with silanol group (viscosity, 0.005 mm²/s), 40 parts of hydrophobically modified fumed silica (Musil 120A manufactured by Shin-Etsu Chemical Co., Ltd. having a specific surface area measured by BET adsorption of 180 m²/g and amount of the hydrophobic group on the silica surface in terms of carbon of 2.8% by weight), 5 parts of hexamethyldisilazane, and 2.5 parts of water were mixed in a kneader and kneaded at room temperature for 1 hour. Next, interior temperature of the kneader was elevated to 160° C. in 60 minutes, and the kneading was continued for another 4 hours at the same temperature. 100 parts by weight of this composition was mixed with 0.05 parts by weight of the antistat paste 1 and 5 parts by weight of a curing agent prepared by mixing 1.0 part of dioctyltindilaurate (tin content in terms of metallic tin, 16% by weight) which is a curing catalyst, 2.2 parts of phenyltrimethoxysilane which is a crosslinking agent, and 1.8 parts of dimethylpolysiloxane endcapped on both ends with trimethylsilyl group, and this mixture was stirred at 25° C. for 1 minute to produce a silicone rubber composition.

A sheet having a thickness of 2 mm was prepared from this silicone rubber composition, and the sheet was cured at 23° C. for 72 hours. This silicone rubber sheet was evaluated for its charge amount (half life) and volume intrinsic resistivity. The results are shown in Table 1.

### Example 2

The procedure of Example 1 was repeated to measure the charge amount and the volume intrinsic resistivity except that the antistat paste 1 was added at an amount of 0.01 parts by weight. The results are shown in Table 1.

### Comparative Example 1

The procedure of Example 1 was repeated to measure the charge amount and the volume intrinsic resistivity except that no antistatic agent was added. The results are shown in Table 1.

### Comparative Example 2

The procedure of Example 1 was repeated to measure the charge amount and the volume intrinsic resistivity except that the antistat paste 2 was used instead of the antistat paste 1. The results are shown in Table 1.

TABLE 1

| | | | Comparative | |
|---|---|---|---|---|
| | Example | | Example | |
| | 1 | 2 | 1 | 2 |
| Charge amount | 1 second | 1 second | 90 second | 80 second |
| (half life) | | | | |
| (6 kV) | | | | |
| Volume | 1.20 × 10¹⁵ | 1.50 × 10¹⁴ | 1.70 × 10¹⁵ | 2.80 × 10¹⁴ |
| intrinsic | | | | |
| resistivity | | | | |
| (Ω · m) | | | | |

### Example 3

A room temperature curable liquid primer for silicone rubber AQ-1 (manufactured by Shin-Etsu Chemical Co., Ltd.) was coated on a stainless steel shaft having a diameter of 1000 mm and a length of 5000 mm, and this layer was overcoated with the composition of Example 1. This layer was cured at 23° C. for 48 hours to produce a large size silicone rubber roll for industrial use having a rubber thickness of 20 mm and a length of 5000 mm.

This large size silicone rubber roll for industrial application was assembled in a drawing machine as a roll for drawing a polyethylene film. A polyethylene film (1000 m) was drawn in this drawing machine, and evaluated for the presence of pin holes formed when dust was attached on the roll surface by static electricity generated by friction. No pin holes were found.

### Comparative Example 3

The procedure of Example 3 was repeated by using the room temperature curable silicone rubber composition containing no antistatic agent produced in Comparative Example 1 instead of the composition produced in Example 1. In the stretching of a polyethylene film as in the case of Example 3, pin hole formation started at 560 m, and 32 pin holes were formed after stretching 1000 m.

Japanese Patent Application Nos. 2006-257315 and 2007-109327 are incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A silicone rubber composition which cures by condensation and which has excellent antistatic properties, wherein the silicone rubber composition contains an ion conductive antistatic agent.

2. The silicone rubber composition which cures by condensation according to claim 1 wherein the ion conductive antistatic agent is a lithium salt.

3. The silicone rubber composition which cures by condensation according to claim 2 wherein the ion conductive antistatic agent is at least one lithium salt selected from LiBF₄, LiClO₄, LiPF₆, LiAsF₆, LiSbF₆, LiSO₃CF₃, LiN(SO₂CF₃)₂, LiSO₃C₄F₉, LiC(SO₂CF₃)₃, and LiB(C₆H₅)₄.

4. The silicone rubber composition which cures by condensation according to claim 1 wherein the ion conductive antistatic agent is added in the form of a paste prepared by using an organopolysiloxane.

5. The silicone rubber composition which cures by condensation according to claim 1 wherein the composition after curing has a volume resistivity of at least one 1 GΩ·m.

6. The silicone rubber composition which cures by condensation according to claim 1 wherein the composition is used as a material in producing a large size industrial roll.

7. The silicone rubber composition which cures by condensation according to claim 1 wherein the composition is used in producing a master template.

8. The silicone rubber composition which cures by condensation according to claim 1 wherein the composition is used as a material for tampon printing.
